(19) United States
(12) Patent Application Publication
(10) Pub. No.: US 2007/0087199 A1
(43) Pub. Date: Apr. 19, 2007

(54) Colored sheet material

(75) Inventors: Fujiyou Yoshimura, Fukui (JP); Yukari Suzuki, Fukui (JP)

Correspondence Address: DILWORTH & BARRESE, LLP, 333 EARLE OVINGTON BLVD., SUITE 702, UNIONDALE, NY, 11553, US

(73) Assignee: Seiren Co., Ltd., Fukui (JP)

(21) Appl. No.: 11/580,795

(22) Filed: Oct. 13, 2006

(30) Foreign Application Priority Data
Oct. 14, 2005 (JP) 2005-300369

(51) Int. Cl. B32B 27/12; B32B 27/00

(52) U.S. Cl. 428/411.1; 442/286; 442/394

(57) ABSTRACT

A colored sheet material is provided which has a colored resin layer as an essential component and which is difficult to rise in its surface temperature even when exposed to an infrared ray contained for example in sunlight for a long time and undergoes little change in color no matter what light may be irradiated, i.e., with reduced color rendering. As the colored resin layer, which is formed on a sheet base of the colored sheet material, there is used a colored resin layer having an average absorptance of not higher than 30% in the wavelength region of 780 to 1800 nm and an average absorptance of not lower than 60% in the wavelength region of 610 to 780 nm.

### FIELD OF THE INVENTION

The present invention relates to a colored sheet material which material is difficult to increase in its surface temperature even when exposed to an infrared ray contained in sunlight or the like for a long time and has reduced color rendering, i.e. undergoes little change in its color no matter what light may be irradiated.

### PRIOR ART

As colored sheet materials having a colored resin layer there are known synthetic leather, polyvinyl chloride leather, artificial leather and natural leather. For coloring these products into a medium deep color, pigments have heretofore been used as colorants. A target hue is obtained by combining a chromatic color pigment with a black color pigment.

Particularly, a carbon black pigment containing carbon as a main component is used as a black color pigment. The carbon black pigment has a high absorptance of infrared rays (wavelength region: 780 to 1800 nm), so when the surface of a colored sheet material containing a carbon black pigment is exposed to light containing an infrared ray, such as sunlight, it produces heat due to absorption of the infrared ray, thus giving rise to the problem that the temperature of the surface of the colored sheet material becomes very high.

To remedy such a problem, Japanese Patent No. 3180235 discloses a leather-like sheet material wherein only a pigment having an infrared ray absorptance of not higher than 50% is used as a colorant, without using a carbonaceous pigment, to form a colored layer, thereby making it possible to prevent the generation and accumulation of heat under sunlight.

JP 2001-187574A, JP 2001-113975A and JP 2001-122044A disclose a surface material for a steering wheel, a shift knob and lining, the surface material having an infrared ray reflecting pigment by addition or coating to the surface to make the surface temperature difficult to rise even in the case of a deep color.

JP 2004-314596A discloses a colored sheet having a heat insulating property, the colored sheet being formed by a laminate of a reflecting layer and a colored layer, the reflecting layer having a solar radiation reflectance of not lower than 60% in the wavelength region of 780 to 1350 nm, the colored layer having a light transmittance of not lower than 30% in the wavelength region of 780 to 1350 nm and a solar radiation absorptance of 10 to 80% in the wavelength region of 380 to 780 nm.

In the above patent literatures there is disclosed an invention wherein a sheet material having a colored resin layer using a pigment of a low infrared absorptance is prepared, thereby affording an appearance of a medium deep color and suppressing the generation and accumulation of heat caused by the absorption of sunlight. However, no reference is made therein to the problem related to color rendering such that the color changes depending on radiated light. In case of preparing the sheet material actually, there has been a fear that the problem of color rendering becoming more conspicuous may occur. Particularly, in the case of a medium deep color (black color), if color rendering is conspicuous, a change in color caused by a difference of light source becomes conspicuous, thus giving rise to the problem that the resulting product is not valid as an industrial product.

### OBJECT OF THE INVENTION

It is an object of the present invention to provide a colored sheet material having a colored resin layer on a sheet base, the colored sheet material being difficult to increase in its surface temperature even when exposed to an infrared ray contained in sunlight or the like for a long time and having reduced color rendering, i.e. undergoing little change in color no matter what light may be irradiated.

### SUMMARY OF THE INVENTION

The present invention firstly resides in a colored sheet material comprising a sheet base and a colored resin layer formed on one or both surfaces of the sheet base, characterized by having an incandescent lamp absorption temperature [FAT (5 min)] of not higher than 40° C. and a color rendering [CR (D65:F6)] of not more than 0.4.

The present invention secondly resides in the above colored sheet material, wherein the colored resin layer has an average absorptance of not higher than 30% in the wavelength region of 780 to 1800 nm and an average absorptance of not lower than 60% in the wavelength region of 610 to 780 nm.

The present invention thirdly resides in the above colored sheet material, wherein the colored resin layer contains a black pigment having an average absorptance of not higher than 30% in the wavelength region of 780 to 1800 nm and an average absorptance of not lower than 60% in the wavelength region of 610 to 780 nm.

The present invention fourthly resides in the above colored sheet material, wherein the colored resin layer contains a black pigment having an average absorptance of not higher than 30% in the wavelength region of 780 to 1800 nm and a chromatic color pigment having an average absorptance of not higher than 30% in the wavelength region of 780 to 1800 nm and an average absorptance of not lower than 60% in the wavelength region of 610 to 780 nm.

### EFFECTS OF THE INVENTION

The colored sheet material of the present invention has a colored resin layer whose average absorptances in specific wavelength regions are defined so that the surface temperature of the colored sheet material is difficult to rise even when the material is exposed to light containing an infrared ray, such as sunlight, for a long time, thereby suppressing an increase of ambient temperature, preventing a user from having an unpleasant feeling, preventing the deterioration of strength caused by heat aging of the colored sheet material, and attains little change in color no matter what light may be irradiated, i.e. has reduced color rendering.

### BRIEF DESCRIPTION OF THE DRAWINGS

FIG. 1 is a sectional view showing an example of a colored sheet material according to the present invention;

FIG. 2 is a sectional view showing another example of a colored sheet material according to the present invention; and

FIG. 3 is a sectional view showing a further example of a colored sheet material according to the present invention.

In the drawings, the numeral 1 denotes a colored resin layer, numeral 2 denotes a fibrous base, numeral 3 denotes an adhesive layer, and numeral 4 denotes natural leather.

### DETAILED DESCRIPTION OF THE INVENTION

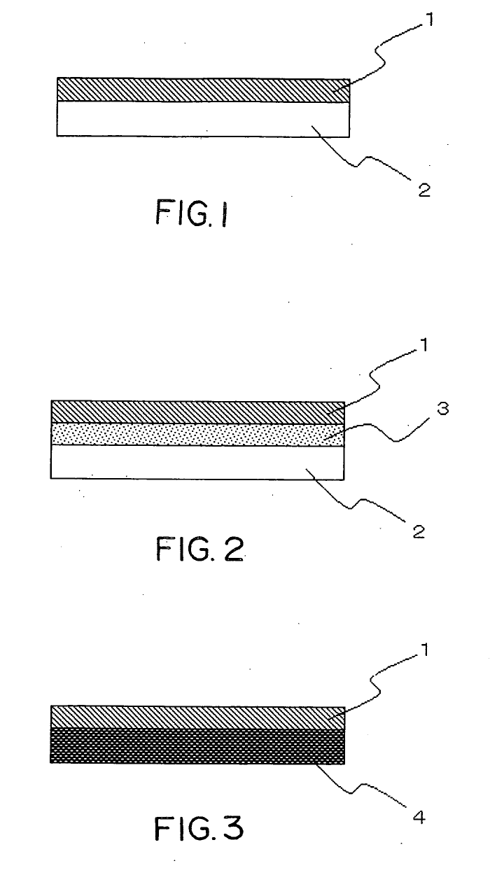

The colored sheet material of the present invention has a colored resin layer on a sheet base. As the sheet base which is a sheet like material there may be used, for example, a fibrous base such as woven, knitted, or non-woven cloth and leather. The colored resin layer may be bonded to one or both surfaces of the sheet base directly or through an adhesive layer. As examples of the colored sheet material of the present invention, mention may be made of such a leather-like colored sheet material as shown in FIG. 1 in which a colored resin layer is laminated to a fibrous sheet base, e.g., woven, knitted, or non-woven cloth, by a known method, for example, dry or wet coating such as spray coating, gravure coating, knife coating, or roll coating, such a leather-like colored sheet material as shown in FIG. 2 in which a fibrous sheet base and a colored resin layer are laminated together through an adhesive layer, and such a natural leather colored sheet material as shown in FIG. 3 in which a colored resin layer is applied to the surface of a natural leather sheet base.

As the resin used in the colored resin layer in the present invention, various known synthetic resins may be used. Examples are polyurethane resin, polyamino acid resin, polyvinyl chloride resin, SBR resin, NBR resin, acrylic resin, polyester resin, and copolymers and mixtures of these resins. From the standpoint of wear resistance and texture, polyurethane resins are preferred (including copolymers thereof and mixtures thereof with other resins, provided in the case of such copolymers and mixtures, it is preferable that the content of urethane component be larger than 50%).

Among them, polycarbonate-based polyurethane resins are particularly preferred. Both aqueous and solvent types of these resins are employable in the present invention.

If necessary, additives so far used commonly, e.g., plasticizer, stabilizer, filler, lubricant, pigment, paint, foaming agent, and mold release agent, may be contained in the synthetic resin.

The colored sheet material of the present invention is characterized in that its incandescent lamp absorption temperature [FAT (5 min)] is not higher than 40° C. and that its color rendering [CR (D65:F6)] is not more than 0.4.

The incandescent lamp absorption temperature FAT (5 min) as referred to herein is measured in the following manner.

Under the condition of an atmospheric temperature of 30° C., a test piece cut 30 cm square is superimposed on a 10 mm thick urethane piece also cut 30 cm square in such a manner that a colored resin layer lies on an upper side. Then, a 300W incandescent lamp is lit at 100V for 5 minutes at a distance of 30 cm spaced away from the test piece and the surface temperature of the test piece is measured after 5 minutes by means of an infrared radiation thermometer. The value obtained by subtracting the atmospheric temperature of 30° C. form the measured temperature was used as FAT (5 min).

When FAT (5 min) is not higher than 40° C., it is possible to suppress an increase of the ambient temperature (atmosphere temperature) due to the increase of the surface temperature. Besides, by cooling with air after the increase of the surface temperature, the surface temperature can be cooled to the ambient temperature relatively early. Thus, it is possible to provide a colored sheet material which gives little unpleasant feeling to a user. It is also possible to prevent the deterioration of strength caused by heat aging.

The color rendering CR (D65:F6) as referred to herein is measured in the following manner.

With respect to the colored resin layer side of the test piece, color values (L*, a*, b*) in D65 light source and F6 light source are measured with a spectrophotometer (Color i5, a product of GretagMacbeth, LLC) and the color rendering is calculated in accordance with the following equation (1):
CR(D65:F6)=[{L*(D65)−L*(F6) }² +{a*(D65)−a*(F6)}²+{b*(D65)−b*(F6)}²]^{1/2} (1)
Color values in D65 light source: L*(D65), a*(D65), woven b*(D65)
Color values in F6 light source: L*(F6), a*(F6), b*(F6)

Since CR (D65:F6) is not more than 0.4, the difference in color of the colored sheet material between the irradiation from D65 light source and that from F6 light source becomes indistinguishable visually. Thus, the colored sheet material can be reduced in the difference of color no matter what light source may be used, i.e., reduced in color rendering.

It is preferable for the colored resin layer in the colored sheet material of the present invention to have an average absorptance of not higher than 30% in the wavelength region of 780 to 1800 nm and an average absorptance of not lower than 60% in the wavelength region of 610 to 780 nm.

In the present invention, the measurement of an average absorptance in each wavelength region of the colored resin layer is performed in the following manner.

In the colored sheet material of the present invention, the colored resin layer alone is formed as a film (the type and proportion of resin and of pigment and the thickness of resin layer are set appropriately according to the purpose) and the film of the colored resin layer thus formed is measured for spectrum of reflectance and that of transmittance by means of a spectrophotometer (UV-3100PC, a product of Shimadzu Corp.). An average reflectance and an average transmittance in the wavelength regions of 780 to 1800 nm and 610 to 780 nm are determined from the spectra and an average absorptance (%) is obtained in accordance with the following equation (2):
Average absorptance (%)={100−(average reflectance+average transmittance)}(%) (2)

If the average absorptance in the infrared wavelength region of 780 to 1800 nm of the colored resin layer is not higher than 30%, then in the case where light containing an infrared ray, such as sunlight, is radiated, the temperature of the colored resin layer does not rise so much because the generation of heat caused by absorption of the infrared ray is not so much, thus affording a colored sheet material whose surface temperature is difficult to rise. If the average absorptance in the wavelength region of 780 to 1800 nm of the colored resin layer is higher than 30%, the colored resin layer is apt to generate heat when exposed to light containing an infrared ray, such as sunlight, resulting in that the surface temperature of the colored sheet material becomes high and that the user may have an unpleasant feeling.

By making the average absorptance in the wavelength region of 610 to 780 nm of the colored resin layer 60% or higher, it is possible to provide a colored sheet material of a reduced difference in color irrespective of the light source used. The reason is that D65 light source (daylight) and F6 light source (white fluorescent light) are greatly different in the spectral distribution of red light in the wavelength region of 610 to 780 nm and that therefore color rendering occurs markedly in the red color portion if an average absorptance in the wavelength region of 610 to 780 nm of red color is low. If an average absorptance in the wavelength region of 610 to 780 nm of the colored resin layer is lower than 60%, the difference in color is significant depending on the light source used, with a consequent fear that the colored sheet material obtained may be unsuitable as an industrial product.

As examples of the pigment used in the colored resin layer in the colored sheet material of the present invention, mention may be made of quinone-, perylene-, azomethine- and phthalocyanine-based organic pigments, as well as titanium oxide-, iron oxide- and compound oxide-based inorganic pigments.

In the present invention, the measurement of an average absorptance in each wavelength region of the pigment is performed in the following manner.

A solution consisting of a polycarbonate-based polyurethane resin (CRISVON NY-328, a product of Dainippon Ink And Chemicals, Incorporated) and dimethylformamide is prepared. The solids content of the polycarbonate-based polyurethane resin is 25 wt % relative to the solution. The pigment is added to the solution so that the solids content thereof is 15 wt % relative to the resin solids content to form a 20 μm thick film. The film is then measured for spectrum of reflectance and that of transmittance by means of a spectrophotometer (UV-3100PC, a product of Shimadzu Corp.). An average reflectance and an average transmittance in the wavelength regions of 780 to 1800 nm and 610 to 780 nm are determined from the spectra and an average absorptance (%) is obtained in accordance with the following equation (2):
Average absorptance (%)={100−(average reflectance+average transmittance)}(%) (2)

By using the foregoing black pigment or a combination thereof with a chromatic color pigment there is obtained a colored sheet material difficult to rise in its surface temperature and reduced in color rendering. If an average absorptance in the wavelength region of 780 to 1800 nm of the black pigment is higher than 30%, the colored sheet material is apt to generate heat and rise in its surface temperature when exposed to light containing an infrared ray, such as sunlight, with a consequent fear that the user may have an unpleasant feeling. If an average absorptance in the wavelength region of 610 to 780 nm of the black pigment is lower than 60%, it is likely that the color rendering may become conspicuous.

As an example of a black pigment which satisfies the condition that the average absorptance in the wavelength region of 780 to 1800 nm should be not higher than 30% and the average absorptance in the wavelength region of 610 to 780 nm should be not lower than 60%, mention may be made of Paliogen Black L0086 (a product of BASF A.G.) as a perylene-based organic pigment.

A black pigment having an average absorptance of not higher than 30% in the wavelength region of 780 to 1800 nm may be combined with at least one chromatic color pigment having an average absorptance of not higher than 30% in the wavelength region of 780 to 1800 nm and an average absorptance of not lower than 60% in the wavelength region of 610 to 780 nm, as will be described later. The reason for such a combined use is that in the case of a colored sheet material of a medium deep color using a black pigment having an average absorptance of not higher than 30% in the wavelength region of 780 to 1800 nm, there sometimes is a case where the color rendering becomes marked, depending on the black pigment used. To remedy such a drawback there is used at least one chromatic color pigment having an average absorptance of not higher than 30% in the wavelength region of 780 to 1800 nm and an average absorptance of not lower than 60% in the wavelength region of 610 to 780 nm, whereby there is formed a colored sheet material whose surface temperature does not rise so much upon exposed to an infrared ray and which is reduced in color rendering.

The black pigment having an average absorptance of not higher than 30% in the wavelength region of 780 to 1800 nm may be selected from among perylene- and azomethine-based organic pigments and titanium oxide- and compound oxide-based inorganic pigments. As examples of the chromatic color pigment having an average absorptance of not higher than 30% in the wavelength region of 780 to 1800 nm and an average absorptance of not lower than 60% in the wavelength region of 610 to 780 nm, there are mentioned pigments which absorbs purple, indigo, and blue in the wavelength region of 380 to 500 nm apart from the wavelength region of 610 to 780 nm of red. For example, a suitable chromatic color pigment may be selected from among quinone-, perylene-, azomethine- and phthalocyanine-based organic pigments, as well as titanium oxide-, iron oxide- and double oxide-based inorganic pigments.

As described earlier, the colored sheet material of the present invention can be prepared by a method wherein a predetermined colored resin solution is applied to one or both surfaces of a sheet base, e.g., knitted cloth, followed by drying, or a method wherein a predetermined colored resin solution is applied onto a release material, e.g., mold release paper, followed by drying to form a skin layer, and the skin layer is laminated to one or both surfaces of a sheet base with use of an adhesive, or a dry coating method.

The predetermined colored resin solution may be an aqueous type or a solvent type. As the solvent there may be used an appropriate solvent suitable for the resin used. Examples include polar organic solvents such as dimethyl sulfoxide, dimethylformamide and dimethylacetamide.

For application of the predetermined colored resin solution there may be used a known dry or wet coating method such as, for example, spray coating, gravure coating, knife coating, or roll coating.

Also as the adhesive to be used for bonding the colored resin layer once formed on mold release paper to a sheet base there may be used a suitable known adhesive. Examples are polyurethane resin, polyamino acid resin, polyvinyl chloride resin, SBR resin, NBR resin, acrylic resin, and polyester resin.

By bonding the above colored resin layer onto a sheet base there can be provided a colored sheet material whose surface temperature is difficult to rise even when exposed to light containing an infrared ray, such as sunlight, for a long time and which is reduced in color rendering.

### EXAMPLES

The present invention will be described below by way of working examples thereof.

Temperature sensitivity and color rendering were evaluated by the following methods.

<Temperature Sensitivity>

Colored sheet materials prepared in Examples and Comparative Examples were each cut 30 cm square. Each of the thus-cut colored sheet materials was then superimposed on a 10 mm thick piece of urethane also cut 30 cm square in such a manner that a colored resin layer lay on an upper side, to afford a test piece. Then, under the condition of an ambient temperature of 30° C., an incandescent lamp of 300 W was lit at 100V for 5 minutes at a distance spaced 30 cm from the test piece. Thereafter, the test piece was touched by ten panel members and a sensory evaluation was performed on the basis of the following criterion.

The evaluation item corresponding to the largest number of panel members was adopted as the evaluation of the colored sheet material concerned.

⊚. . . comfortable

∘. . . somewhat comfortable

Δ. . . somewhat discomfortable

X . . . discomfortable

<Color Rendering>

Colored sheet materials prepared in Examples and Comparative Examples were visually checked by ten panel members under irradiation using D65 light source and irradiation using F6 light source and were checked for a difference between the use of D65 light source and that of F6 light source as to how the color of each colored sheet material is seen. A sensory evaluation was performed on the basis of the following criterion:

⊚. . . no difference in color

∘. . . a slight difference in color

Δ. . . difference in color

X . . . a marked difference in color

### Example 1

In accordance with the following formulation 1 a resin solution was prepared and the viscosity thereof was adjusted to 2000 cps. The resin solution was applied to mold release paper to a coating thickness of 200 μm and then dried at 100° C. for 2 minutes to afford a colored resin layer. In the following description, “parts” means “parts by weight.”

An adhesive was prepared by adding dimethylformamide to a polycarbonate-based polyurethane resin (CRISVON TA-205, a product of Dainippon Ink And Chemicals, Incorporated) to adjust the viscosity to 5000 cps and was applied to the colored resin layer to a coating thickness of 200 μm, followed by drying at 100° C. for 1 minute. The thus-coated colored resin layer was press-bonded to polyester tricot cloth under the condition of 4 kgf/cm² for 1 minute to afford a colored sheet material. Data on pigment are shown in Table 1 and the results obtained are shown in Table 2.

[Formulation 1]

| | | |
|---|---|---|
| Polycarbonate-based polyurethane resin | 100 | parts |
| (CRISVON NY-328, a product of Dainippon | | |
| Ink And Chemicals, Incorporated) | | |
| DMF | 40 | parts |
| Black pigment (Paliogen Black L0086 | 3 | parts |
| (perylene-based), a product of BASF A.G.) | | |

### Example 2

In accordance with the following formulation 2 a resin solution was prepared and the viscosity thereof was adjusted to 2000 cps. The resin solution was applied to mold release paper to a coating thickness of 200 μm and then dried at 100° C. for 2 minutes to afford a colored resin layer.

An adhesive was prepared by adding dimethylformamide to a polycarbonate-based polyurethane resin (CRISVON TA-205, a product of Dainippon Ink And Chemicals, Incorporated) to adjust the viscosity to 5000 cps and was applied to the colored resin layer to a coating thickness of 200 μm, followed by drying at 100° C. for 1 minute. The thus-coated colored resin layer was press-bonded to polyester tricot cloth under the condition of 4 kgf/cm² for 1 minute to afford a colored sheet material. Data on pigments are shown in Table 1 and the results obtained are shown in Table 2.

[Formulation 2]

| | | |
|---|---|---|
| Polycarbonate-based polyurethane resin | 100 | parts |
| (CRISVON NY-328, a product of Dainippon | | |
| Ink And Chemicals, Incorporated) | | |
| DMF | 40 | parts |
| Black pigment (Paliogen Black L0084 | 2 | parts |
| (perylene-based), a product of BASF A.G.) | | |
| Chromatic color pigments | | |
| (DIALAC BLUE L-1779S (phthalocyanine- | 15 | parts |
| based), a product of Dainippon Ink And | | |
| Chemicals, Incorporated) | | |
| (DIALAC YELLOW L-1778S (iron oxide- | 2 | parts |
| based), a product of Dainippon Ink And | | |
| Chemicals, Incorporated) | | |

### Example 3

In accordance with the following formulation 3 and with use of a thickener there was prepared a coating solution having a viscosity of about 40 seconds (NK-2, a product of ANEST IWATA Corp., a coating material discharge and drop time was measured using a viscosity cup). The coating solution thus prepared was sprayed to natural leather (crust) to a coating quantity of 150 g/m², followed by drying at 80° C. and subsequent resin aging, embossing and milling to afford a colored sheet material. Data on pigment are shown in Table 1 and the results obtained are shown in Table 2.

[Formulation 3]

| | | |
|---|---|---|
| Polycarbonate-based polyurethane resin | 150 | parts |
| (BAYDERM Bottom 51UD, a product of | | |
| Rankcess K.K.) | | |
| Acrylic resin (PRIMAL SB-100, a product | 150 | parts |
| of Rankcess K.K.) | | |
| Black pigment (Paliogen Black L0086 | 150 | parts |
| (perylene-based), a product of BASF A.G.) | | |
| Water | 100 | parts |
| Urethane-based thickener (ACRYSOL RM- | X | parts |
| 1020, a product of Rankcess K.K.) | | |

### Comparative Example 1

In accordance with the following formulation 4 a resin solution was prepared and the viscosity thereof was adjusted to 2000 cps. The resin solution was applied to mold release paper to a coating thickness of 200 μm and then dried at 100° C. for 2 minutes to afford a colored resin layer.

An adhesive was prepared by adding dimethylformamide to a polycarbonate-based polyurethane resin (CRISVON TA-205, a product of Dainippon Ink And Chemicals, Incorporated) to adjust the viscosity to 5000 cps and was applied to the colored resin layer to a coating thickness of 200 μm, followed by drying at 100° C. for 1 minute. The thus-coated colored resin layer was press-bonded to polyester tricot cloth under the condition of 4 kgf/cm² for 1 minute to afford a colored sheet material. Data on pigment are shown in Table 1 and the results obtained are shown in Table 2.

[Formulation 4]

| | | |
|---|---|---|
| Polycarbonate-based polyurethane resin | 100 | parts |
| (CRISVON NY-328, a product of Dainippon | | |
| Ink And Chemicals, Incorporated) | | |
| DMF | 40 | parts |
| Black pigment (DIALAC BLACK L-1770S | 15 | parts |
| (carbon black), a product of Dainippon | | |
| Ink And Chemicals, Incorporated) | | |

### Comparative Example 2

In accordance with the following formulation 5 a resin solution was prepared and the viscosity thereof was adjusted to 2000 cps. The resin solution was applied to mold release paper to a coating thickness of 200 μm and then dried at 100° C. for 2 minutes to afford a colored resin layer.

An adhesive was prepared by adding dimethylformamide to a polycarbonate-based polyurethane resin (CRISVON TA-205, a product of Dainippon Ink And Chemicals, Incorporated) to adjust the viscosity to 5000 cps and was applied to the colored resin layer to a coating thickness of 200 μm, followed by drying at 100° C. for 1 minute. The thus-coated colored resin layer was press-bonded to polyester tricot cloth under the condition of 4 kgf/cm² for 1 minute to afford a colored sheet material. Data on pigment are shown in Table 1 and the results obtained are shown in Table 2.

[Formulation 5]

| | | |
|---|---|---|
| Polycarbonate-based polyurethane resin | 100 | parts |
| (CRISVON NY-328, a product of Dainippon | | |
| Ink And Chemicals, Incorporated) | | |
| DMF | 40 | parts |
| Black pigment (Paliogen BLACK L0084 | 3 | parts |
| (perylene-based), a product of BASF A.G.) | | |

TABLE 1

| | | Average Absorptance | |
|---|---|---|---|
| | | in Different | |
| | | Wavelength (%) | |
| | | 780-1800 | 610-780 |
| | Pigment Name | nm | nm |
| 1 | Paliogen Black L0086 (BASF (A.G.)) | 9.79 | 79.46 |
| 2 | Paliogen Black L0084 (BASF (A.G.)) | 8.56 | 57.40 |
| 3 | DIALAC BLACK L-1770S (Dainippon | 91.24 | 99.84 |
| | Ink And Chemicals, Inc.) | | |
| 4 | DIALAC YELLOW L-1778S (Dainippon | 7.32 | 30.13 |
| | Ink And Chemicals, Inc.) | | |
| 5 | DIALAC BLUE L-1779S (Dainippon | 7.86 | 91.45 |
| | Ink And Chemicals, Inc.) | | |

TABLE 2

| | | Average Absorptance in | | | | | |
|---|---|---|---|---|---|---|---|
| | | Different Wavelength Regions | | | | | |
| | Pigment | of Colored Resin Layer, (%) | | Temperature | Color | FAT | CR |
| | used | 780-1800 nm | 610-780 nm | Sensitivity | Rendering | (5 min) | (D65:F6) |
| Example 1 | 1 | 9.79 | 79.46 | ◯ | ◯ | 30.7 | 0.147 |
| Example 2 | 2, 4, 5 | 8.72 | 66.67 | ◯ | ◯ | 27.8 | 0.145 |
| Example 3 | 1 | 9.80 | 79.45 | ◯ | ◯ | 31.0 | 0.148 |
| Com. Ex. 1 | 3 | 85.17 | 99.79 | X | ⊚ | 57.7 | 0.041 |
| Com. Ex. 2 | 2 | 8.56 | 57.40 | ◯ | X | 30.5 | 1.183 |

What is claimed is:

1. A colored sheet material comprising a sheet base and a colored resin layer formed on one or both surfaces of the sheet base, characterized by having an incandescent lamp absorption temperature [FAT (5 min)] of not higher than 40° C. and a color rendering [CR (D65:F6)] of not more than 0.4.

2. A colored sheet material as set forth in claim 1, wherein said colored resin layer has an average absorptance of not higher than 30% in the wavelength region of 780 to 1800 nm and an average absorptance of not lower than 60% in the wavelength region of 610 to 780 nm.

3. A colored sheet material as set forth in claim 1, wherein said colored resin layer contains a black pigment having an average absorptance of not higher than 30% in the wavelength region of 780 to 1800 nm and an average absorptance of not lower than 60% in the wavelength region of 610 to 780 nm.

4. A colored sheet material as set forth in claim 1, wherein said colored resin layer contains a black pigment having an average absorptance of not higher than 30% in the wavelength region of 780 to 1800 nm and a chromatic color pigment having an average absorptance of not higher than 30% in the wavelength region of 780 to 1800 nm and an average absorptance of not lower than 60% in the wavelength region of 610 to 780 nm.

5. A colored sheet material as set forth in claim 1, wherein said sheet base is fibrous cloth or leather.

6. A colored sheet material as set forth in claim 1, wherein an adhesive layer is present between said sheet base and said colored resin layer.
